(19) United States
(12) Patent Application Publication
(10) Pub. No.: US 2018/0113209 A1
(43) Pub. Date: Apr. 26, 2018

(54) Radar generated occupancy grid for autonomous vehicle perception and planning

(71) Applicant: Waymo LLC, Mountain View, CA (US)

(72) Inventor: Timothy Campbell, Los Angeles, CA (US)

(21) Appl. No.: 15/299,970

(22) Filed: Oct. 21, 2016

(51) Int. Cl. G01S 13/93; G01S 13/86; G01S 13/42

(52) U.S. Cl. CPC G01S 13/931; G01S 17/936; G01S 13/42; G01S 13/865

(57) ABSTRACT

Systems and methods are described that relate to generating an object grid for a vehicular radar system. The method includes transmitting a radar signal over a 360-degree azimuth. The method also includes receiving one or more reflection signals respectively associated with reflection of the transmitted radar signal by one or more objects. The method further includes determining, for each object, a respective measured angle, a respective measured distance, and a respective measured velocity. Additionally, the method includes determining a first object grid based on the one or more objects. The first object grid comprises a plurality angles that together cover the 360-degree azimuth and, for each angle that corresponds to a measured angle of a given object, the first grid associates the angle with the measured distance and measured velocity of the given object. Yet further, the method includes controlling an autonomous vehicle based on the first object grid.

### BACKGROUND

Unless otherwise indicated herein, the materials described in this section are not prior art to the claims in this application and are not admitted to be prior art by inclusion in this section.

A vehicle could be any wheeled, powered vehicle and may include a car, truck, motorcycle, bus, etc. Vehicles can be utilized for various tasks such as transportation of people and goods, as well as many other uses.

Some vehicles may be partially or fully autonomous. For instance, when a vehicle is in an autonomous mode, some or all of the driving aspects of vehicle operation can be handled by a vehicle control system. In such cases, computing devices located onboard and/or in a server network could be operable to carry out functions such as planning a driving route, sensing aspects of the vehicle, sensing the environment of the vehicle, and controlling drive components such as steering, throttle, and brake. Thus, autonomous vehicles may reduce or eliminate the need for human interaction in various aspects of vehicle operation.

An autonomous vehicle may use various sensors to receive information about the environment in which the vehicle operates. A laser scanning system may emit laser light into an environment. The laser scanning system may emit laser radiation having a time-varying direction, origin or pattern of propagation with respect to a stationary frame of reference. Such systems may use the emitted laser light to map a three-dimensional model of their surroundings (e.g., LIDAR).

Radio detection and ranging (RADAR) systems can be used to actively estimate distances to environmental features by emitting radio signals and detecting returning reflected signals. Distances to radio-reflective features can be determined according to the time delay between transmission and reception. The radar system can emit a signal that varies in frequency over time, such as a signal with a time-varying frequency ramp, and then relate the difference in frequency between the emitted signal and the reflected signal to a range estimate. Some systems may also estimate relative motion of reflective objects based on Doppler frequency shifts in the received reflected signals. Directional antennas can be used for the transmission and/or reception of signals to associate each range estimate with a bearing. More generally, directional antennas can also be used to focus radiated energy on a given field of view of interest. Combining the measured distances and the directional information allows for the surrounding environment features to be identified and/or mapped. The radar sensor can thus be used, for instance, by an autonomous vehicle control system to avoid obstacles indicated by the sensor information.

### SUMMARY

In an aspect, a method is provided. The method includes transmitting, by a radar unit of a vehicle, a radar signal over a 360-degree azimuth. The method also includes receiving one or more reflection signals respectively associated with reflection of the transmitted radar signal by one or more objects. The method further includes determining, by a processor, for each object of the one or more objects, a respective measured angle, a respective measured distance, and a respective measured velocity. Additionally, the method includes determining a first object grid based on the one or more objects. The first object grid comprises a plurality angles that together cover the 360-degree azimuth and, for each angle in the plurality of angles that corresponds to a measured angle of a given object in the one or more objects, the first grid associates the angle with the measured distance and measured velocity of the given object. Yet further, the method includes controlling an autonomous vehicle based on the first object grid.

In another aspect, a system is provided. The system includes a radar unit configured to transmit and receive radar signals over a 360-degree azimuth plane, where the receiving comprises receiving one or more reflection signals respectively associated with reflection of the transmitted radar signal by one or more objects. The system also includes a control unit configured to operate a vehicle according to a control plan. Additionally, the system also includes a processing unit. The processing unit is configured to determine for each object of the one or more objects, a respective measured angle, a respective measured distance, and a respective measured velocity. The processing unit is also configured to determine a first object grid based on the one or more objects, where the first object grid comprises a plurality angles that together cover the 360-degree azimuth and, for each angle in the plurality of angles that corresponds to a measured angle of a given object in the one or more objects, the first grid associates the angle with the measured distance and measured velocity of the given object. Additionally, processing unit is configured to alter the control plan based on the first object grid.

In yet another aspect, an article of manufacture including a non-transitory computer-readable medium, having stored program instructions that, if executed by a computing device, cause the computing device to perform operations is provided. The operations include transmitting, by a radar unit of a vehicle, a radar signal over a 360-degree azimuth. The operations also include receiving one or more reflection signals respectively associated with reflection of the transmitted radar signal by one or more objects. The operations further include determining, by a processor, for each object of the one or more objects, a respective measured angle, a respective measured distance, and a respective measured velocity. Additionally, the operations include determining a first object grid based on the one or more objects. The first object grid comprises a plurality angles that together cover the 360-degree azimuth and, for each angle in the plurality of angles that corresponds to a measured angle of a given object in the one or more objects, the first grid associates the angle with the measured distance and measured velocity of the given object. Yet further, the operations include controlling an autonomous vehicle based on the first object grid.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates a system, according to an example embodiment.

FIG. 2A illustrates a laser light emission scenario, according to an example embodiment.

FIG. 2B illustrates a laser light emission scenario, according to an example embodiment.

FIG. 2C illustrates a radar light emission scenario, according to an example embodiment.

FIG. 3 illustrates a schematic block diagram of a vehicle, according to an example embodiment.

FIG. 4A illustrates several views of a vehicle, according to an example embodiment.

FIG. 4B illustrates a scanning environment around a vehicle, according to an example embodiment.

FIG. 4C illustrates a scanning environment around a vehicle, according to an example embodiment.

FIG. 5A illustrates a representation of a scene, according to an example embodiment.

FIG. 5B illustrates a representation of a scene, according to an example embodiment.

FIG. 6 illustrates a method, according to an example embodiment.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### Overview

A vehicle may include various sensors in order to receive information about the environment in which the vehicle operates. RADAR and LIDAR systems can be used to actively estimate distances to environmental features by emitting radio or light signals and detecting returning reflected signals. Distances to reflective features can be determined according to the time delay between transmission and reception.

The radar system can emit a radio frequency (RF) signal that varies in frequency over time, such as a signal with a time-varying frequency ramp, and then relate the difference in frequency between the emitted signal and the reflected signal to a range estimate. Some radar systems may also estimate relative motion of reflective objects based on Doppler frequency shifts in the received reflected signals. Directional antennas can be used for the transmission and/or reception of signals to associate each range estimate with a bearing. More generally, directional antennas can also be used to focus radiated energy on a given field of view of interest. Combining the measured distances and the directional information allows for the surrounding environment features to be mapped. The radar sensor can thus be used, for instance, by an autonomous vehicle control system to avoid obstacles indicated by the sensor information. Additionally, the radar signal may be scanned across the 360-degree azimuth plane to develop a two-dimension reflectivity map of objects in the field of view.

Some example automotive radar systems may be configured to operate at an electromagnetic wave frequency of 77 Giga-Hertz (GHz), which corresponds to millimeter (mm) electromagnetic wave length (e.g., 3.9 mm for 77 GHz). These radar systems may use antennas that can focus the radiated energy into tight beams in order to enable the radar system to measure an environment with high accuracy, such as an environment around an autonomous vehicle. Such antennas may be compact (typically with rectangular form factors; e.g., 1.3 inches high by 2.5 inches wide), efficient (i.e., there should be little 77 GHz energy lost to heat in the antenna, or reflected back into the transmitter electronics), and easy to manufacture.

LIDAR may be used in a similar manner to RADAR. However, LIDARs transmit optical signals rather than RF signals. LIDAR may provide a higher resolution as compared to RADAR. Additionally, a LIDAR signal may be scanned over a three-dimensional region to develop a 3D point map of objects in the field of view. On the other hand, LIDAR may not provide the same level of information related to the motion of object as what RADAR can provide.

One aspect of the present disclosure provides an operation mode for the RADAR system of the vehicle. The RADAR system may be operated with a radar beam that can scan all or a portion of the 360-degree azimuth plane around the vehicle. As the beam scans the azimuth plane, it will receive reflections from objects that reflect radar signals. When an object reflects radar signals, the radar system may be able to determine an angle to the object, a distance to the object, and a velocity of the object. Based on the various reflections received by the radar unit, an object grid can be created. The object grid may be a spatial representation of the various reflecting objects and their associated parameters.

An autonomous vehicle may use the object grid in order to determine movement parameters for the autonomous vehicle. For example, the vehicle may be able to determine that two other vehicles are traveling in front of the vehicle at different speeds. In another example, the vehicle may be able to determine that an object is moving toward the vehicle, such as a gate that is closing. The vehicle may be able to adjust its movement based on the object grid in order to avoid objects.

In some further examples, the object grid may be used as part of a sensor fusion system. In a sensor fusion system, various sensors are used in combination in order to provide more accurate information. Sensor fusion may be beneficial when some sensors have properties that provide information that is not feasible to receive from other sensors. In some examples, a LIDAR sensor may be able to provide an object grid with a high resolution. However, LIDAR may not be able to measure velocity as accurately as RADAR. Additionally, in some situations, such as fog, rain, and other situations, LIDAR systems may incorrectly identify obstacles. For example, a LIDAR system may identify fog as a solid object. Conversely, RADAR may be able to accurately measure velocity of objects and create an object cloud that can “see through” fog. However, a RADAR system may have a lower resolution than a LIDAR system. Thus, by combining object clouds created by LIDAR and RADAR systems may be able provide more accurate information about the vehicle's surrounding, while mitigating the negative effects of each respective system.

### System Examples

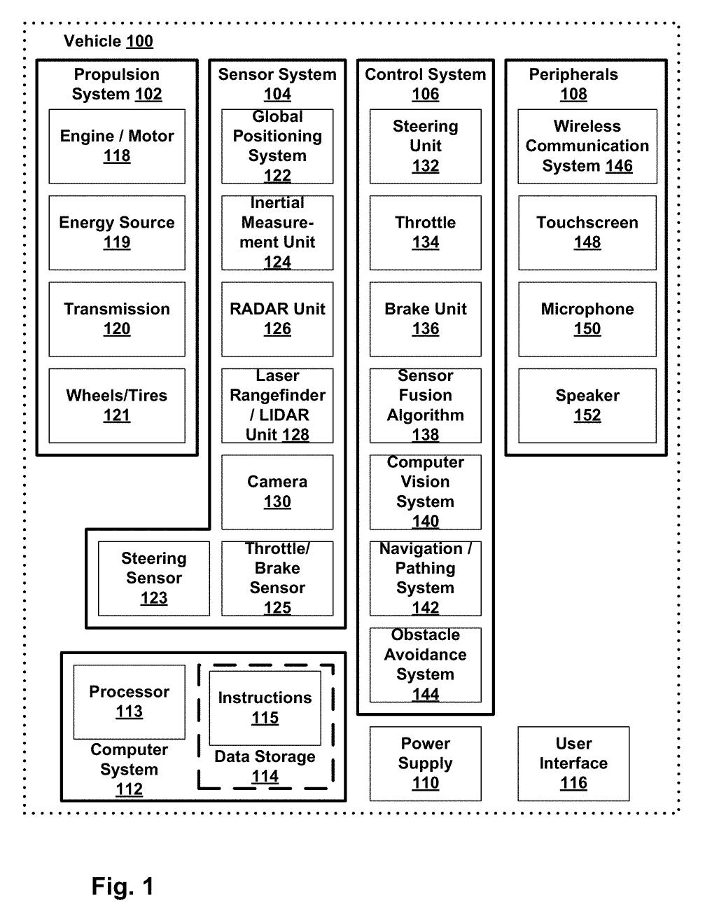

FIG. 1 is a functional block diagram illustrating a vehicle 100, according to an example embodiment. The vehicle 100 could be configured to operate fully or partially in an autonomous mode. While in autonomous mode, the vehicle 100 may be configured to operate without human interaction. For example, a computer system could control the vehicle 100 while in the autonomous mode, and may be operable to operate the vehicle an autonomous mode. As part of operating in the autonomous mode, the vehicle may identify objects of the environment around the vehicle. In response, the computer system may alter the control of the autonomous vehicle.

The vehicle 100 could include various subsystems such as a propulsion system 102, a sensor system 104, a control system 106, one or more peripherals 108, as well as a power supply 110, a computer system 112, a data storage 114, and a user interface 116. The vehicle 100 may include more or fewer subsystems and each subsystem could include multiple elements. Further, each of the subsystems and elements of vehicle 100 could be interconnected. Thus, one or more of the described functions of the vehicle 100 may be divided up into additional functional or physical components, or combined into fewer functional or physical components. In some further examples, additional functional and/or physical components may be added to the examples illustrated by FIG. 1.

The propulsion system 102 may include components operable to provide powered motion for the vehicle 100. Depending upon the embodiment, the propulsion system 102 could include an engine/motor 118, an energy source 119, a transmission 120, and wheels/tires 121. The engine/motor 118 could be any combination of an internal combustion engine, an electric motor, steam engine, Stirling engine. Other motors and/or engines are possible. In some embodiments, the engine/motor 118 may be configured to convert energy source 119 into mechanical energy. In some embodiments, the propulsion system 102 could include multiple types of engines and/or motors. For instance, a gas-electric hybrid car could include a gasoline engine and an electric motor. Other examples are possible.

The energy source 119 could represent a source of energy that may, in full or in part, power the engine/motor 118. Examples of energy sources 119 contemplated within the scope of the present disclosure include gasoline, diesel, other petroleum-based fuels, propane, other compressed gas-based fuels, ethanol, solar panels, batteries, and other sources of electrical power. The energy source(s) 119 could additionally or alternatively include any combination of fuel tanks, batteries, capacitors, and/or flywheels. The energy source 118 could also provide energy for other systems of the vehicle 100.

The transmission 120 could include elements that are operable to transmit mechanical power from the engine/motor 118 to the wheels/tires 121. The transmission 120 could include a gearbox, a clutch, a differential, and a drive shaft. Other components of transmission 120 are possible. The drive shafts could include one or more axles that could be coupled to the one or more wheels/tires 121.

The wheels/tires 121 of vehicle 100 could be configured in various formats, including a unicycle, bicycle/motorcycle, tricycle, or car/truck four-wheel format. Other wheel/tire geometries are possible, such as those including six or more wheels. Any combination of the wheels/tires 121 of vehicle 100 may be operable to rotate differentially with respect to other wheels/tires 121. The wheels/tires 121 could represent at least one wheel that is fixedly attached to the transmission 120 and at least one tire coupled to a rim of the wheel that could make contact with the driving surface. The wheels/tires 121 could include any combination of metal and rubber. Other materials are possible.

The sensor system 104 may include several elements such as a Global Positioning System (GPS) 122, an inertial measurement unit (IMU) 124, a radar 126, a laser rangefinder/LIDAR 128, a camera 130, a steering sensor 123, and a throttle/brake sensor 125. The sensor system 104 could also include other sensors, such as those that may monitor internal systems of the vehicle 100 (e.g., O₂ monitor, fuel gauge, engine oil temperature, brake wear).

The GPS 122 could include a transceiver operable to provide information regarding the position of the vehicle 100 with respect to the Earth. The IMU 124 could include a combination of accelerometers and gyroscopes and could represent any number of systems that sense position and orientation changes of a body based on inertial acceleration. Additionally, the IMU 124 may be able to detect a pitch and yaw of the vehicle 100. The pitch and yaw may be detected while the vehicle is stationary or in motion.

The radar 126 may represent a system that utilizes radio signals to sense objects, and in some cases their speed and heading, within the local environment of the vehicle 100. Additionally, the radar 126 may have a plurality of antennas configured to transmit and receive radio signals. The laser rangefinder/LIDAR 128 could include one or more laser sources, a laser scanner, and one or more detectors, among other system components. The laser rangefinder/LIDAR 128 could be configured to operate in a coherent mode (e.g., using heterodyne detection) or in an incoherent detection mode. The camera 130 could include one or more devices configured to capture a plurality of images of the environment of the vehicle 100. The camera 130 could be a still camera or a video camera.

The steering sensor 123 may represent a system that senses the steering angle of the vehicle 100. In some embodiments, the steering sensor 123 may measure the angle of the steering wheel itself. In other embodiments, the steering sensor 123 may measure an electrical signal representative of the angle of the steering wheel. Still, in further embodiments, the steering sensor 123 may measure an angle of the wheels of the vehicle 100. For instance, an angle of the wheels with respect to a forward axis of the vehicle 100 could be sensed. Additionally, in yet further embodiments, the steering sensor 123 may measure a combination (or a subset) of the angle of the steering wheel, electrical signal representing the angle of the steering wheel, and the angle of the wheels of vehicle 100.

The throttle/brake sensor 125 may represent a system that senses the position of either the throttle position or brake position of the vehicle 100. In some embodiments, separate sensors may measure the throttle position and brake position. In some embodiments, the throttle/brake sensor 125 may measure the angle of both the gas pedal (throttle) and brake pedal. In other embodiments, the throttle/brake sensor 125 may measure an electrical signal that could represent, for instance, an angle of a gas pedal (throttle) and/or an angle of a brake pedal. Still, in further embodiments, the throttle/brake sensor 125 may measure an angle of a throttle body of the vehicle 100. The throttle body may include part of the physical mechanism that provides modulation of the energy source 119 to the engine/motor 118 (e.g., a butterfly valve or carburetor). Additionally, the throttle/brake sensor 125 may measure a pressure of one or more brake pads on a rotor of vehicle 100. In yet further embodiments, the throttle/brake sensor 125 may measure a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, the throttle/brake sensor 125 could be configured to measure a pressure applied to a pedal of the vehicle, such as a throttle or brake pedal.

The control system 106 could include various elements include steering unit 132, throttle 134, brake unit 136, a sensor fusion algorithm 138, a computer vision system 140, a navigation/pathing system 142, and an obstacle avoidance system 144. The steering unit 132 could represent any combination of mechanisms that may be operable to adjust the heading of vehicle 100. The throttle 134 could control, for instance, the operating speed of the engine/motor 118 and thus control the speed of the vehicle 100. The brake unit 136 could be operable to decelerate the vehicle 100. The brake unit 136 could use friction to slow the wheels/tires 121. In other embodiments, the brake unit 136 could convert the kinetic energy of the wheels/tires 121 to electric current.

A sensor fusion algorithm 138 could include, for instance, a Kalman filter, Bayesian network, or other algorithm that may accept data from sensor system 104 as input. The sensor fusion algorithm 138 could provide various assessments based on the sensor data. Depending upon the embodiment, the assessments could include evaluations of individual objects and/or features, evaluation of a particular situation, and/or evaluate possible impacts based on the particular situation. Other assessments are possible.

The computer vision system 140 could include hardware and software operable to process and analyze images in an effort to determine objects, important environmental objects (e.g., stop lights, road way boundaries, etc.), and obstacles. The computer vision system 140 could use object recognition, Structure From Motion (SFM), video tracking, and other algorithms used in computer vision, for instance, to recognize objects, map an environment, track objects, estimate the speed of objects, etc.

The navigation/pathing system 142 could be configured to determine a driving path for the vehicle 100. The navigation/pathing system 142 may additionally update the driving path dynamically while the vehicle 100 is in operation. In some embodiments, the navigation/pathing system 142 could incorporate data from the sensor fusion algorithm 138, the GPS 122, and known maps so as to determine the driving path for vehicle 100.

The obstacle avoidance system 144 could represent a control system configured to evaluate potential obstacles based on sensor data and control the vehicle 100 to avoid or otherwise negotiate the potential obstacles.

Various peripherals 108 could be included in vehicle 100. For example, peripherals 108 could include a wireless communication system 146, a touchscreen 148, a microphone 150, and/or a speaker 152. The peripherals 108 could provide, for instance, means for a user of the vehicle 100 to interact with the user interface 116. For example, the touchscreen 148 could provide information to a user of vehicle 100. The user interface 116 could also be operable to accept input from the user via the touchscreen 148. In other instances, the peripherals 108 may provide means for the vehicle 100 to communicate with devices within its environment.

In one example, the wireless communication system 146 could be configured to wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 could communicate with a wireless local area network (WLAN), for example, using WiFi. In some embodiments, wireless communication system 146 could communicate directly with a device, for example, using an infrared link, Bluetooth, or ZigBee. Other wireless protocols, such as various vehicular communication systems, are possible within the context of the disclosure. For example, the wireless communication system 146 could include one or more dedicated short-range communications (DSRC) devices that could include public and/or private data communications between vehicles and/or roadside stations.

The power supply 110 may provide power to various components of vehicle 100 and could represent, for example, a rechargeable lithium-ion or lead-acid battery. In an example embodiment, one or more banks of such batteries could be configured to provide electrical power. Other power supply materials and types are possible. Depending upon the embodiment, the power supply 110, and energy source 119 could be integrated into a single energy source, such as in some all-electric cars.

Many or all of the functions of vehicle 100 could be controlled by computer system 112. Computer system 112 may include at least one processor 113 (which could include at least one microprocessor) that executes instructions 115 stored in a non-transitory computer readable medium, such as the data storage 114. The computer system 112 may also represent a plurality of computing devices that may serve to control individual components or subsystems of the vehicle 100 in a distributed fashion.

In some embodiments, data storage 114 may contain instructions 115 (e.g., program logic) executable by the processor 113 to execute various functions of vehicle 100, including those described above in connection with FIG. 1. Data storage 114 may contain additional instructions as well, including instructions to transmit data to, receive data from, interact with, and/or control one or more of the propulsion system 102, the sensor system 104, the control system 106, and the peripherals 108.

In addition to the instructions 115, the data storage 114 may store data such as roadway maps, path information, among other information. Such information may be used by vehicle 100 and computer system 112 during the operation of the vehicle 100 in the autonomous, semi-autonomous, and/or manual modes.

The vehicle 100 may include a user interface 116 for providing information to or receiving input from a user of vehicle 100. The user interface 116 could control or enable control of content and/or the layout of interactive images that could be displayed on the touchscreen 148. Further, the user interface 116 could include one or more input/output devices within the set of peripherals 108, such as the wireless communication system 146, the touchscreen 148, the microphone 150, and the speaker 152.

The computer system 112 may control the function of the vehicle 100 based on inputs received from various subsystems (e.g., propulsion system 102, sensor system 104, and control system 106), as well as from the user interface 116. For example, the computer system 112 may utilize input from the sensor system 104 in order to estimate the output produced by the propulsion system 102 and the control system 106. Depending upon the embodiment, the computer system 112 could be operable to monitor many aspects of the vehicle 100 and its subsystems. In some embodiments, the computer system 112 may disable some or all functions of the vehicle 100 based on signals received from sensor system 104.

The components of vehicle 100 could be configured to work in an interconnected fashion with other components within or outside their respective systems. For instance, in an example embodiment, the camera 130 could capture a plurality of images that could represent information about a state of an environment of the vehicle 100 operating in an autonomous mode. The state of the environment could include parameters of the road on which the vehicle is operating. For example, the computer vision system 140 may be able to recognize the slope (grade) or other features based on the plurality of images of a roadway. Additionally, the combination of Global Positioning System 122 and the features recognized by the computer vision system 140 may be used with map data stored in the data storage 114 to determine specific road parameters. Further, the radar unit 126 may also provide information about the surroundings of the vehicle.

In other words, a combination of various sensors (which could be termed input-indication and output-indication sensors) and the computer system 112 could interact to provide an indication of an input provided to control a vehicle or an indication of the surroundings of a vehicle.

In some embodiments, the computer system 112 may make a determination about various objects based on data that is provided by systems other than the radio system. For example, the vehicle may have lasers or other optical sensors configured to sense objects in a field of view of the vehicle. The computer system 112 may use the outputs from the various sensors to determine information about objects in a field of view of the vehicle. The computer system 112 may determine distance and direction information to the various objects. The computer system 112 may also determine whether objects are desirable or undesirable based on the outputs from the various sensors.

Although FIG. 1 shows various components of vehicle 100, i.e., wireless communication system 146, computer system 112, data storage 114, and user interface 116, as being integrated into the vehicle 100, one or more of these components could be mounted or associated separately from the vehicle 100. For example, data storage 114 could, in part or in full, exist separate from the vehicle 100. Thus, the vehicle 100 could be provided in the form of device elements that may be located separately or together. The device elements that make up vehicle 100 could be communicatively coupled together in a wired and/or wireless fashion.

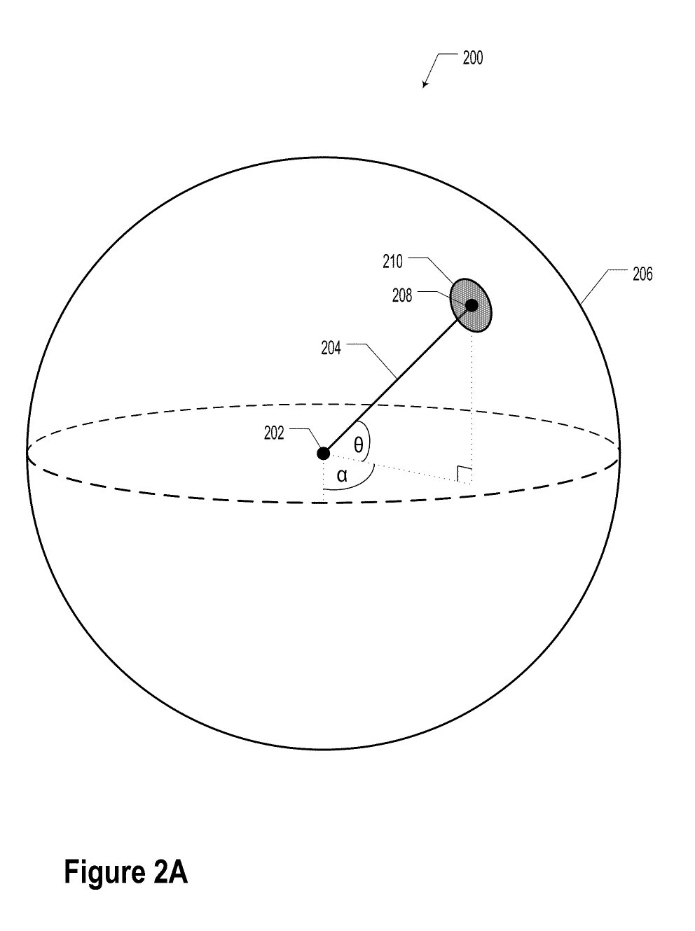

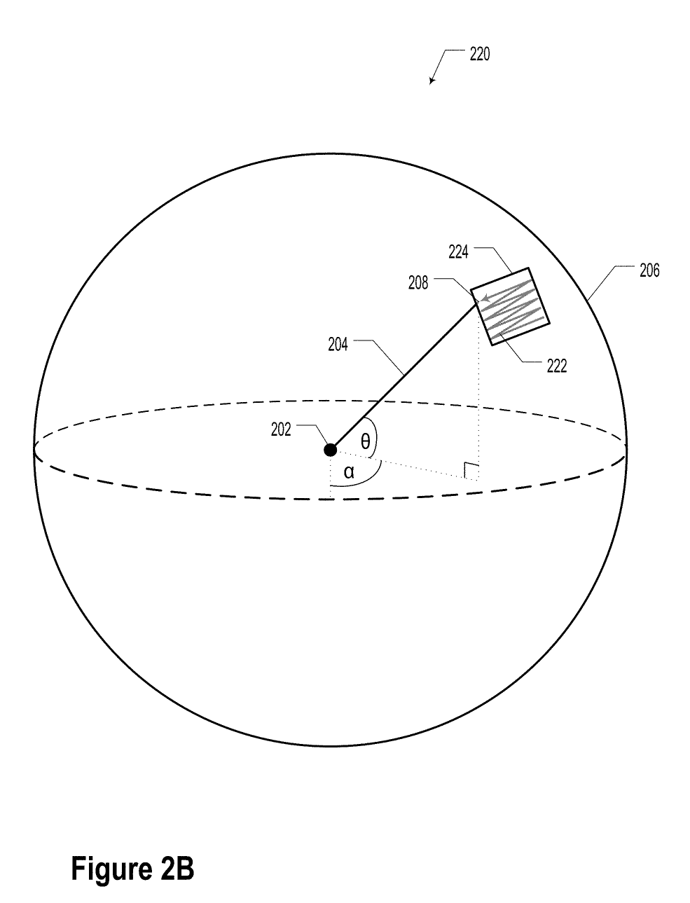

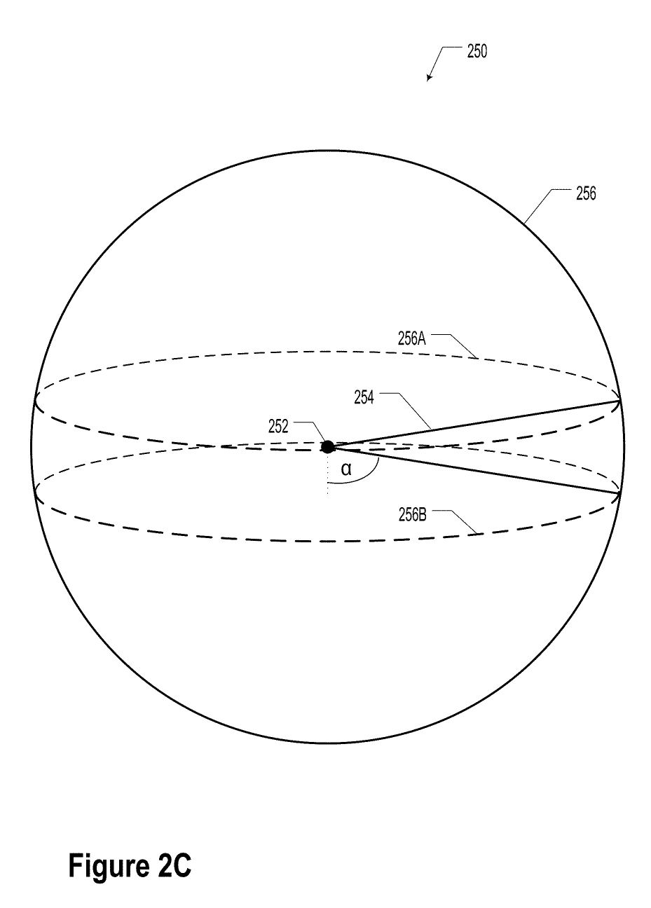

FIG. 2A illustrates a laser light emission scenario 200, according to an example embodiment. In scenario 200, a laser light source 202 (e.g., laser light source from the laser unit 128 as illustrated and described with regard to FIG. 1) may be located at an origin of an imaginary sphere 206. The imaginary sphere 206 may be known as a laser scanning volume. The laser light source 202 may emit laser light in the form of a laser beam 204 at a given angle θ and azimuth α. The laser beam 204 may intersect the sphere 206 at beam spot 208. Local beam region 210 may account for beam widening due to atmospheric conditions, beam collimation, diffraction, etc. The angle θ and azimuth α may be adjusted to scan a laser beam over a portion, a region, or the entire scanning volume.

FIG. 2B illustrates a laser light emission scenario 220, according to an example embodiment. Scenario 220 includes the laser light source 202 being controlled by a scanner (not illustrated) to scan a laser beam 204 and corresponding beam spot 208 along a scanning path 222 within a scanning region 224.

While FIG. 2B illustrates the scanning path 222 as being continuous, it is understood that the scanning path 222, or portions thereof, could be illuminated by continuous or pulsed laser light from the laser light source 202. Furthermore, the laser light source 202 and/or the corresponding laser scanner may scan the laser beam 204 at a fixed and/or variable movement rate along the scanning path.

FIG. 2C illustrates a radar emission scenario 250, according to an example embodiment. In scenario 250, a radar source 252 (e.g., radar from the radar unit 126 as illustrated and described with regard to FIG. 1) may be located at an origin of an imaginary sphere 256. The radar source 252 may emit a radar signal in the form of a radar beam 254 at a given azimuth α. The radar beam 254 may intersect the sphere 206 in the beam region bounded by 256A and 256B. Additionally, the radar beam 254 may be scanned in azimuth α around the full 360-degree azimuth plane within the beam region bounded by 256A and 256B. In some examples, the radar may be scanned around the azimuth plane over the region bounded by 256A and 256B. In other examples, the radar may be scanned in elevation too, similar to as discussed with respect to FIG. 2A.

In some embodiments, the systems and methods described herein may be applied to a laser and radar scanning system incorporated into a vehicle, such as an autonomous automobile. As such, some or all aspects of system 100 as illustrated and described with regard to FIGS. 1, 2A, 2B, and 2C may be applied in the context of an autonomous vehicle (e.g., a self-driving car).

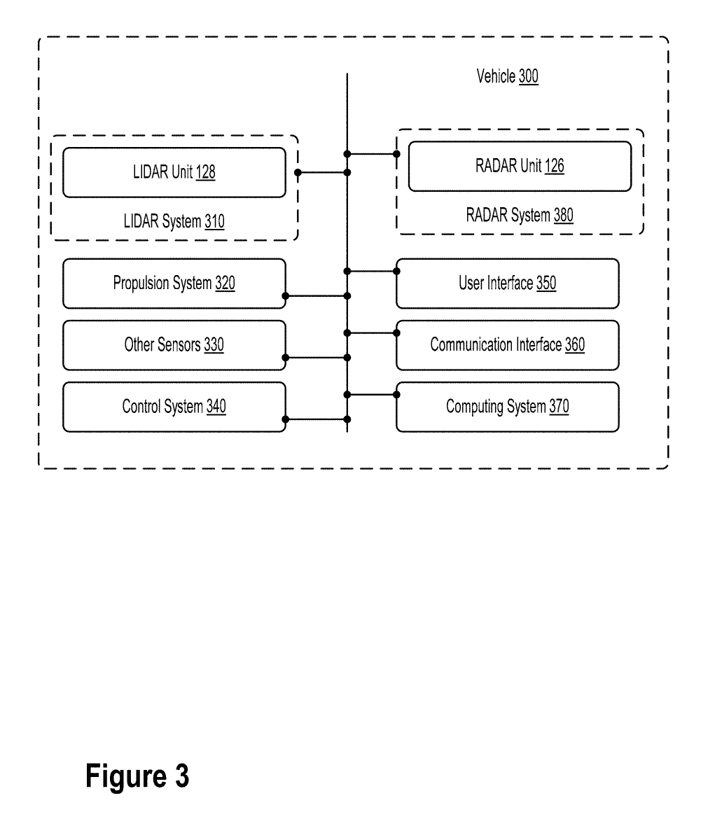

FIG. 3 illustrates a schematic block diagram of a vehicle 300, according to an example embodiment. The vehicle 300 may include a plurality of sensors configured to sense various aspects of an environment around the vehicle. Specifically, vehicle 300 may include a LIDAR system 310 having one or more LIDAR units 128, each with different fields of view, ranges, and/or purposes. Additionally, vehicle 300 may include a RADAR system 380 having one or more RADAR units 126, each with different fields of view, ranges, and/or purposes.

In one example, the LIDAR system 310 may include a single laser beam having a relatively narrow laser beam spread. The laser beam spread may be about 0.1°×0.03° resolution, however other beam resolutions are possible. The LIDAR system 310 may be mounted to a roof of a vehicle, although other mounting locations are possible.

In such a scenario, the laser beam may be steerable over 360° about a vertical axis extending through the vehicle. For example, the LIDAR system 310 may be mounted with a rotational bearing configured to allow it to rotate about a vertical axis. A stepper motor may be configured to control the rotation of the LIDAR system 310. Furthermore, the laser beam may be steered about a horizontal axis such that the beam can be moved up and down. For example, a portion of the LIDAR system 310, e.g. various optics, may be coupled to the LIDAR system mount via a spring. The various optics may be moved about the horizontal axis such that the laser beam is steered up and down. The spring may include a resonant frequency. The resonant frequency may be around 140 Hz. Alternatively, the resonant frequency may be another frequency. The laser beam may be steered using a combination of mirrors, motors, springs, magnets, lenses, and/or other known means to steer light beams.

In an example embodiment, the scanning laser system 110 of FIG. 3 may include a fiber laser light source that emits 1550 nm laser light, although other wavelengths and types of laser sources are possible. Furthermore, the pulse repetition rate of the LIDAR light source may be 200 kHz. The effective range of LIDAR system 310 may be 300 meters, or more.

The laser beam may be steered by a control system of the vehicle or a control system associated with the LIDAR system 310. For example, in response to the vehicle approaching an intersection, the LIDAR system may scan for oncoming traffic to the left and oncoming traffic to the right. Other sensing scenarios are possible.

In an example embodiment, the LIDAR system 310 may be steered so as to identify particular objects. For example, the LIDAR system 310 may be operable to identify the shoulders or another part of a pedestrian. In another example, the LIDAR system 310 may be operable to identify the wheels on a bicycle.

As a specific example, a general-purpose LIDAR system may provide data related to, for instance, a car passing on the vehicle's right. A controller may determine target information based on the data from the general-purpose LIDAR system. Based on the target information, the controller may cause the LIDAR system disclosed herein to scan for the specific passing car and evaluate the target object with higher resolution and/or with a higher pulse repetition rate.

In another example, the RADAR system 380 may include a single radar beam having a radar beam width of 1 degree or less (measured in degrees of the azimuth plane). In one example, the RADAR system 380 may include a dense multiple-input multiple-output (MIMO) array, designed to synthesize a uniform linear array (ULA) with a wide baseline. For example, the RADAR system 380 may include a virtual 60 element array with approximately 1 degree or less azimuth resolution at W band (approximately 77 Gigahertz). The RADAR system 380 may also perform matched filtering in range and azimuth rather than in range and Doppler. The RADAR system 380 may use data from RADAR units 126 to synthesize a radar reflectivity map of the 360-degree azimuth plane degrees around the car. The RADAR system 380 may be mounted to a roof of a vehicle, although other mounting locations are possible.

In such a scenario, the radar beam may be steerable over the 360-degree azimuth plane about a vertical axis extending through the vehicle. For example, the RADAR system 380 may be configured to perform digital beamforming to scan the beam around the azimuth plane. In an example embodiment, the radar unit 126 of FIG. 3 may include a radar signal source that emits a radar signal of approximately 77 GHz, although other wavelengths and types of radar signals sources are possible.

The RADAR beam may be steered by a control system of the vehicle or a control system associated with the RADAR system 380. In some examples, the RADAR system 380 may continuously scan a radar beam of the RADAR unit 128 around the azimuth plane. In other examples, the RADAR system 380 may scan the radar beam of the RADAR unit 128 over areas of interest of the azimuth plane. For example, in response to the vehicle approaching an intersection, the RADAR system 380 may scan for oncoming traffic to the left and oncoming traffic to the right. Other sensing scenarios are possible.

In an example embodiment, similar to the LIDAR system 310, the RADAR system 380 may be steered so as to identify particular objects. For example, the RADAR system 380 may be operable to identify the velocity of objects within the field of view of the radar.

The LIDAR system 310 and the RADAR system 380 described herein may operate in conjunction with other sensors on the vehicle. For example, the LIDAR system 310 may be used to identify specific objects in particular situations. The RADAR system 380 may also identify objects, and provide information (such as object velocity) that is not easily obtained by way of the LIDAR system 310. Target information may be additionally or alternatively determined based on data from any one of, or a combination of, other sensors associated with the vehicle.

Vehicle 300 may further include a propulsion system 320 and other sensors 330. Vehicle 300 may also include a control system 340, user interface 350, and a communication interface 360. In other embodiments, the vehicle 300 may include more, fewer, or different systems, and each system may include more, fewer, or different components. Additionally, the systems and components shown may be combined or divided in any number of ways.

The propulsion system 320 may be configured to provide powered motion for the vehicle 300. For example, the propulsion system 320 may include an engine/motor, an energy source, a transmission, and wheels/tires. The engine/motor may be or include any combination of an internal combustion engine, an electric motor, a steam engine, and a Stirling engine. Other motors and engines are possible as well. In some embodiments, the propulsion system 320 may include multiple types of engines and/or motors. For instance, a gas-electric hybrid car may include a gasoline engine and an electric motor. Other examples are possible.

The energy source may be a source of energy that powers the engine/motor in full or in part. That is, the engine/motor may be configured to convert the energy source into mechanical energy. Examples of energy sources include gasoline, diesel, propane, other compressed gas-based fuels, ethanol, solar panels, batteries, and other sources of electrical power. The energy source(s) may additionally or alternatively include any combination of fuel tanks, batteries, capacitors, and/or flywheels. The energy source may include, for example, one or more rechargeable lithium-ion or lead-acid batteries. In some embodiments, one or more banks of such batteries could be configured to provide electrical power.

In some embodiments, the energy source may provide energy for other systems of the vehicle 300 as well.

The transmission may be configured to transmit mechanical power from the engine/motor to the wheels/tires. To this end, the transmission may include a gearbox, clutch, differential, drive shafts, and/or other elements. In embodiments where the transmission includes drive shafts, the drive shafts may include one or more axles that are configured to be coupled to the wheels/tires.

The wheels/tires of vehicle 300 may be configured in various formats, including a unicycle, bicycle/motorcycle, tricycle, or car/truck four-wheel format. Other wheel/tire formats are possible as well, such as those including six or more wheels. In any case, the wheels/tires may be configured to rotate differentially with respect to other wheels/tires. In some embodiments, the wheels/tires may include at least one wheel that is fixedly attached to the transmission and at least one tire coupled to a rim of the wheel that could make contact with the driving surface. The wheels/tires may include any combination of metal and rubber, or combination of other materials. The propulsion system 320 may additionally or alternatively include components other than those shown.

The other sensors 330 may include a number of sensors (apart from the LIDAR system 310) configured to sense information about an environment in which the vehicle 300 is located, and optionally one or more actuators configured to modify a position and/or orientation of the sensors. As a list of non-limiting examples, the other sensors 330 may include a Global Positioning System (GPS), an inertial measurement unit (IMU), a RADAR unit, a rangefinder, and/or a camera. Further sensors may include those configured to monitor internal systems of the vehicle 300 (e.g., an O₂ monitor, a fuel gauge, an engine oil temperature, etc.). Other sensors are possible as well.

The GPS may be any sensor (e.g., location sensor) configured to estimate a geographic location of the vehicle 300. To this end, the GPS may include a transceiver configured to estimate a position of the vehicle 300 with respect to the Earth. The GPS may take other forms as well.

The IMU may be any combination of sensors configured to sense position and orientation changes of the vehicle 300 based on inertial acceleration. In some embodiments, the combination of sensors may include, for example, accelerometers and gyroscopes. Other combinations of sensors are possible as well.

Similarly, the range finder may be any sensor configured to sense a distance to objects in the environment in which the vehicle 300 is located. The camera may be any camera (e.g., a still camera, a video camera, etc.) configured to capture images of the environment in which the vehicle 300 is located. To this end, the camera may take any of the forms described above. The other sensors 330 may additionally or alternatively include components other than those shown.

The control system 340 may be configured to control operation of the vehicle 300 and its components. To this end, the control system 340 may include a steering unit, a throttle, a brake unit, a sensor fusion algorithm, a computer vision system, a navigation or pathing system, and an obstacle avoidance system.

The steering unit may be any combination of mechanisms configured to adjust the heading of vehicle 300. The throttle may be any combination of mechanisms configured to control the operating speed of the engine/motor and, in turn, the speed of the vehicle. The brake unit may be any combination of mechanisms configured to decelerate the vehicle 300. For example, the brake unit may use friction to slow the wheels/tires. As another example, the brake unit may convert the kinetic energy of the wheels/tires to electric current. The brake unit may take other forms as well.

The sensor fusion algorithm may be an algorithm (or a computer program product storing an algorithm) configured to accept data from various sensors (e.g., LIDAR system 310, RADAR system 380, and/or other sensors 330) as an input. The data may include, for example, data representing information sensed at the various sensors of the vehicle's sensor system. The sensor fusion algorithm may include, for example, a Kalman filter, a Bayesian network, an algorithm configured to perform some of the functions of the methods herein, or any other algorithm. The sensor fusion algorithm may further be configured to provide various assessments based on the data from the sensor system, including, for example, evaluations of individual objects and/or features in the environment in which the vehicle 300 is located, evaluations of particular situations, and/or evaluations of possible impacts based on particular situations. Other assessments are possible as well.

The computer vision system may be any system configured to process and analyze images captured by the camera in order to identify objects and/or features in the environment in which the vehicle 300 is located, including, for example, traffic signals and obstacles. To this end, the computer vision system may use an object recognition algorithm, a Structure from Motion (SFM) algorithm, video tracking, or other computer vision techniques. In some embodiments, the computer vision system may additionally be configured to map the environment, track objects, estimate the speed of objects, etc.

The navigation and pathing system may be configured to determine a driving path for the vehicle 300. The navigation and pathing system may additionally be configured to update the driving path dynamically while the vehicle 300 is in operation. In some embodiments, the navigation and pathing system may be configured to incorporate data from the sensor fusion algorithm, the GPS, the LIDAR system 310, and one or more predetermined maps so as to determine the driving path for vehicle 300.

The obstacle avoidance system may be configured to identify, evaluate, and avoid or otherwise negotiate obstacles in the environment in which the vehicle 300 is located. The control system 340 may additionally or alternatively include components other than those shown.

User interface 350 may be configured to provide interactions between the vehicle 300 and a user. To this end, the user interface 350 may include, for example, a touchscreen, a keyboard, a microphone, and/or a speaker.

The touchscreen may be used by a user to input commands to the vehicle 300. To this end, the touchscreen may be configured to sense at least one of a position and a movement of a user's finger via capacitive sensing, resistance sensing, or a surface acoustic wave process, among other possibilities. The touchscreen may be capable of sensing finger movement in a direction parallel or planar to the touchscreen surface, in a direction normal to the touchscreen surface, or both, and may also be capable of sensing a level of pressure applied to the touchscreen surface. The touchscreen may be formed of one or more translucent or transparent insulating layers and one or more translucent or transparent conducting layers. The touchscreen may take other forms as well.

The microphone may be configured to receive audio (e.g., a voice command or other audio input) from a user of the vehicle 300. Similarly, the speakers may be configured to output audio to the user of the vehicle 300. The user interface 350 may additionally or alternatively include other components.

The communication interface 360 may be any system configured to provide wired or wireless communication between one or more other vehicles, sensors, or other entities, either directly or via a communication network. To this end, the communication interface 360 may include an antenna and a chipset for communicating with the other vehicles, sensors, servers, or other entities either directly or via a communication network. The chipset or communication interface 360 in general may be arranged to communicate according to one or more types of wireless communication (e.g., protocols) such as BLUETOOTH, BLUETOOTH LOW ENERGY (BLE), communication protocols described in IEEE 802.11 (including any IEEE 802.11 revisions), cellular technology (such as GSM, CDMA, UMTS, EV-DO, WiMAX, or LTE), ZIGBEE, dedicated short range communications (DSRC), and radio frequency identification (RFID) communications, among other possibilities. The communication interface 360 may take other forms as well.

The computing system 370 may be configured to transmit data to, receive data from, interact with, and/or control one or more of the LIDAR system 310, propulsion system 320, the other sensors 330, the control system 340, the user interface 350, and the communication interface 360. To this end, the computing system 370 may be communicatively linked to one or more of the LIDAR system 310, propulsion system 320, the other sensors 330, the control system 340, and the user interface 350 via the communication interface 360, a system bus, network, and/or other connection mechanism.

In one example, the computer system 370 may be configured to store and execute instructions for determining a 3D representation of the environment around the vehicle 300 using a combination of the LIDAR system 310 and the RADAR system 380. Additionally or alternatively, the computing system 370 may be configured to control operation of the transmission to improve fuel efficiency. As another example, the computing system 370 may be configured to cause the camera to capture images of the environment. As yet another example, the computing system 370 may be configured to store and execute instructions corresponding to the sensor fusion algorithm. Other examples are possible as well.

The computing system 370 may include at least one processor and a memory. The processor may include one or more general-purpose processors and/or one or more special-purpose processors. To the extent the computing system 370 includes more than one processor, such processors could work separately or in combination. The memory may include one or more volatile and/or one or more non-volatile storage components, such as optical, magnetic, and/or organic storage. The memory may be integrated in whole or in part with the processor(s).

In some embodiments, the memory may contain instructions (e.g., program logic) executable by the processor(s) to execute various functions, such as the blocks described with regard to method 600 and illustrated in FIG. 7. The memory may contain additional instructions as well, including instructions to transmit data to, receive data from, interact with, and/or control one or more of the LIDAR system 310, propulsion system 320, the other sensors 330, the control system 340, and the user interface 350. The computing system 370 may additionally or alternatively include components other than those shown.

The embodiments disclosed herein may be used on any type of vehicle, including conventional automobiles and automobiles having an autonomous mode of operation. However, the term “vehicle” is to be broadly construed to cover any moving object, including, for instance, a truck, a van, a semi-trailer truck, a motorcycle, a golf cart, an off-road vehicle, a warehouse transport vehicle, or a farm vehicle, as well as a carrier that rides on a track such as a rollercoaster, trolley, tram, or train car, among other examples.

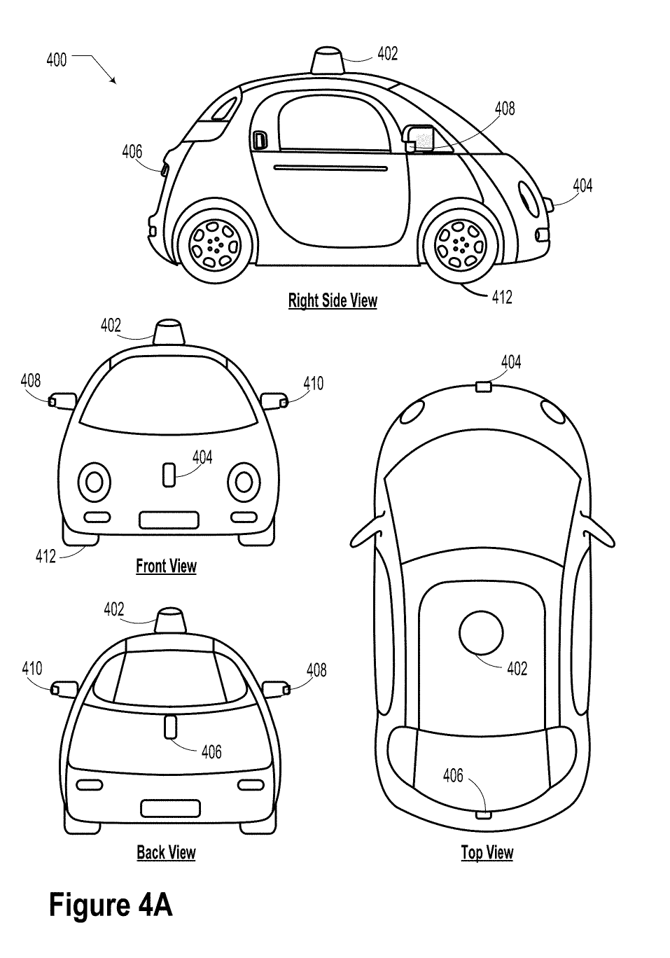

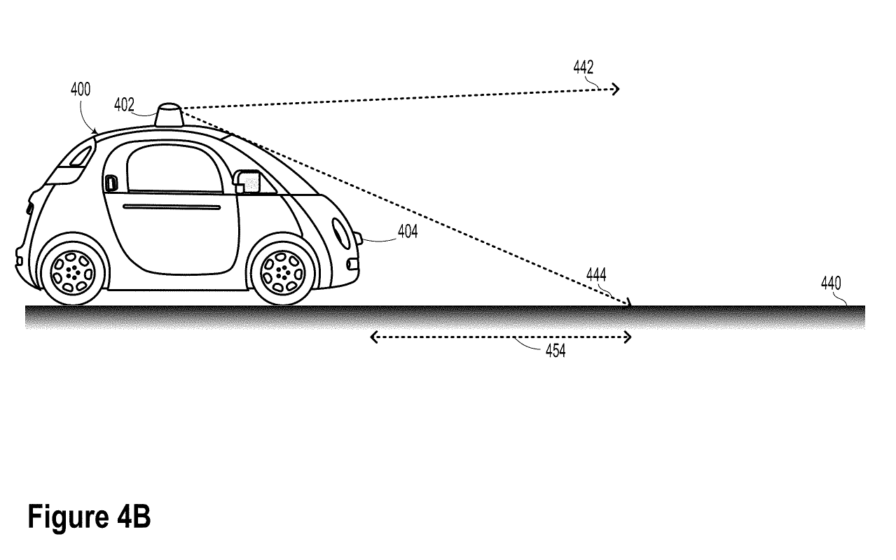

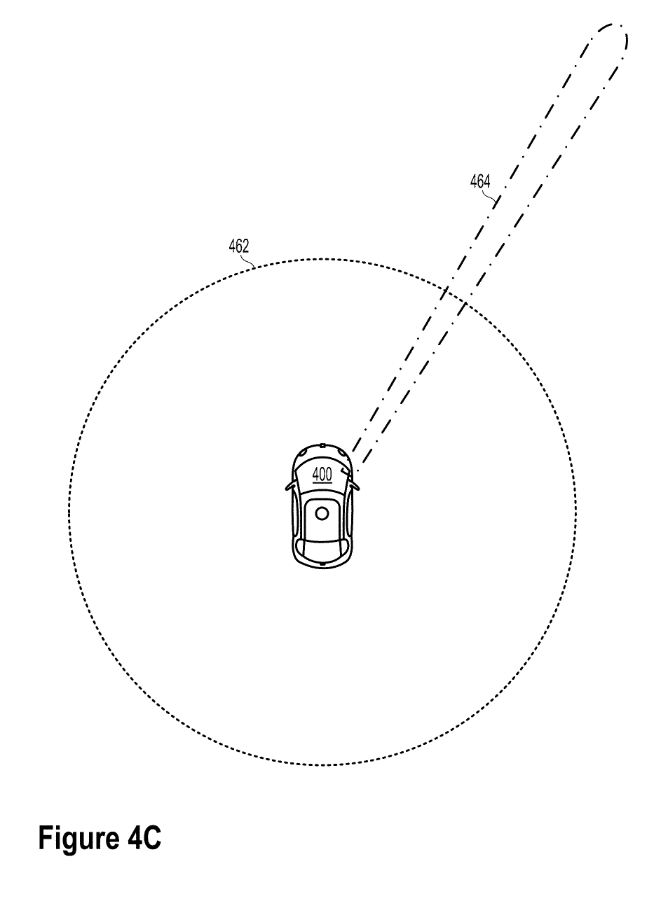

FIG. 4A illustrates a vehicle 400, according to an example embodiment. In particular, FIG. 4A shows a Right Side View, Front View, Back View, and Top View of the vehicle 400. Although vehicle 400 is illustrated in FIG. 4A as a car, as discussed above, other embodiments are possible. Furthermore, although the example vehicle 400 is shown as a vehicle that may be configured to operate in autonomous mode, the embodiments described herein are also applicable to vehicles that are not configured to operate autonomously or in both autonomous and non-autonomous modes. Thus, the example vehicle 400 is not meant to be limiting. As shown, the vehicle 400 includes five sensor units 402, 404, 406, 408, and 410, and four wheels, exemplified by wheel 412.

In line with the discussion above, each of the sensor units 402, 404, 406, 408, and 410 may include one or more light detection and ranging devices (LIDARs) that may be configured to scan an environment around the vehicle 400 according to various road conditions or scenarios. Additionally or alternatively, in some embodiments, the sensor units 402, 404, 406, 408, and 410 may include any combination of global positioning system sensors, inertial measurement units, radio detection and ranging (RADAR) units, cameras, laser rangefinders, LIDARs, and/or acoustic sensors among other possibilities.

As shown, the sensor unit 402 is mounted to a top side of the vehicle 400 opposite to a bottom side of the vehicle 400 where the wheel 412 is mounted. Further, the sensor units 404, 406, 408, and 410 are each mounted to a given side of the vehicle 400 other than the top side. For example, the sensor unit 404 is positioned at a front side of the vehicle 400, the sensor 406 is positioned at a back side of the vehicle 400, the sensor unit 408 is positioned at a right side of the vehicle 400, and the sensor unit 410 is positioned at a left side of the vehicle 400.

While the sensor units 402, 404, 406, 408, and 410 are shown to be mounted in particular locations on the vehicle 400, in some embodiments, the sensor units 402, 404, 406, 408, and 410 may be mounted elsewhere on the vehicle 400, either inside or outside the vehicle 400. For example, although FIG. 4A shows the sensor unit 408 mounted to a right-side rear-view mirror of the vehicle 400, the sensor unit 408 may alternatively be positioned in another location along the right side of the vehicle 400. Further, while five sensor units are shown, in some embodiments more or fewer sensor units may be included in the vehicle 400.

In some embodiments, one or more of the sensor units 402, 404, 406, 408, and 410 may include one or more movable mounts on which the sensors may be movably mounted. The movable mount may include, for example, a rotating platform. Sensors mounted on the rotating platform could be rotated so that the sensors may obtain information from various directions around the vehicle 400. For example, a LIDAR of the sensor unit 402 may have a viewing direction that can be adjusted by actuating the rotating platform to a different direction, etc. Alternatively or additionally, the movable mount may include a tilting platform. Sensors mounted on the tilting platform could be tilted within a given range of angles and/or azimuths so that the sensors may obtain information from a variety of angles. The movable mount may take other forms as well.

Further, in some embodiments, one or more of the sensor units 402, 404, 406, 408, and 410 may include one or more actuators configured to adjust the position and/or orientation of sensors in the sensor unit by moving the sensors and/or movable mounts. Example actuators include motors, pneumatic actuators, hydraulic pistons, relays, solenoids, and piezoelectric actuators. Other actuators are possible as well.

As shown, the vehicle 400 includes one or more wheels such as the wheel 412 that are configured to rotate to cause the vehicle to travel along a driving surface. In some embodiments, the wheel 412 may include at least one tire coupled to a rim of the wheel 412. To that end, the wheel 412 may include any combination of metal and rubber, or a combination of other materials. The vehicle 400 may include one or more other components in addition to or instead of those shown.

As shown in FIG. 4B, the sensor unit 402 (including a LIDAR unit and/or a radar unit) may scan for objects in the environment of the vehicle 400 in any direction around the vehicle 400 (e.g., by rotating, etc.), but may be less suitable for scanning the environment for objects in close proximity to the vehicle 400. For example, as shown, objects within distance 454 to the vehicle 400 may be undetected or may only be partially detected by the sensors of the sensor unit 402 due to positions of such objects being outside the region between the light pulses or radar signals illustrated by the arrows 442 and 444.

It is noted that the angles between the various arrows 442-440 shown in FIG. 4B are not to scale and are for illustrative purposes only. Thus, in some examples, the vertical FOVs of the various LIDARs may vary as well.

FIG. 4C illustrates a top view of the vehicle 400 in a scenario where the vehicle 400 is scanning a surrounding environment with a LIDAR and/or RADAR unit. In line with the discussion above, each of the various LIDARs of the vehicle 400 may have a particular resolution according to its respective refresh rate, FOV, or any other factor. In turn, the various LIDARs may be suitable for detection and/or identification of objects within a respective range of distances to the vehicle 400. Additionally, the RADARs of the vehicle 400 may be able to scan a RADAR beam around the vehicle to detect objects and their velocities.

As shown in FIG. 4C, contour 462 illustrates the azimuth plane around the vehicle 400. Both the LIDAR and the RADAR units may be configured to detect and/or identify around the azimuth plane 462. The RADAR and LIDAR may be able to scan a beam 464 across the azimuth plane, as described with respect to FIGS. 2A-2C. The vehicle may be able to create an object grid for each of the LIDAR and RADAR scanning. Each object grid may specify the angle, distance, and/or velocity of the various object detected by the LIDAR and the RADAR.

In some examples the vehicle may compare the data from the two object grids in order to determine additional parameters of the objects that caused reflections and remove errors from an object grid. For example, a LIDAR sensor may see a cloud of fog or water spray as a solid object. However, the RADAR sensor may see through the fog or water spray to identify objects on the other side of the fog or water spray. Thus, the vehicle control system may operate the vehicle based on the objects detected by the RADAR sensor rather than that detected incorrectly by the LIDAR sensors.

In another example, information from the RADAR object grid may provide supplemental information to the object grid from the LIDAR sensor. For example, LIDAR sensors may not accurately provide information related to the velocity of objects, while, RADAR sensors may not be able to discriminate between two different metal objects as well as LIDAR. Therefore, in one situation a vehicle may be driving behind two other vehicles, such as semi-trucks, that occupy the two lanes in front of the vehicle. The RADAR sensors may be able to provide accurate velocity information about each of the trucks, but may not be able to easily resolve the separation between the two trucks. Conversely, LIDAR sensors may be able to provide accurate velocity information about each.

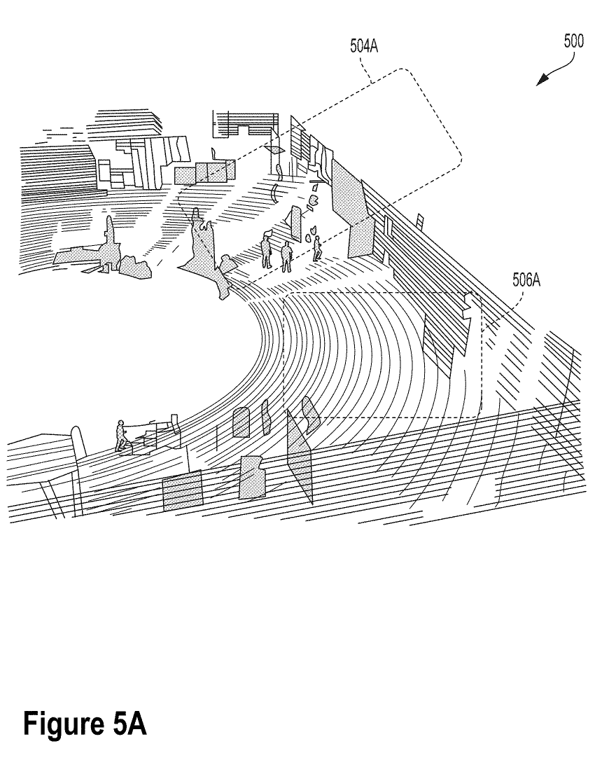

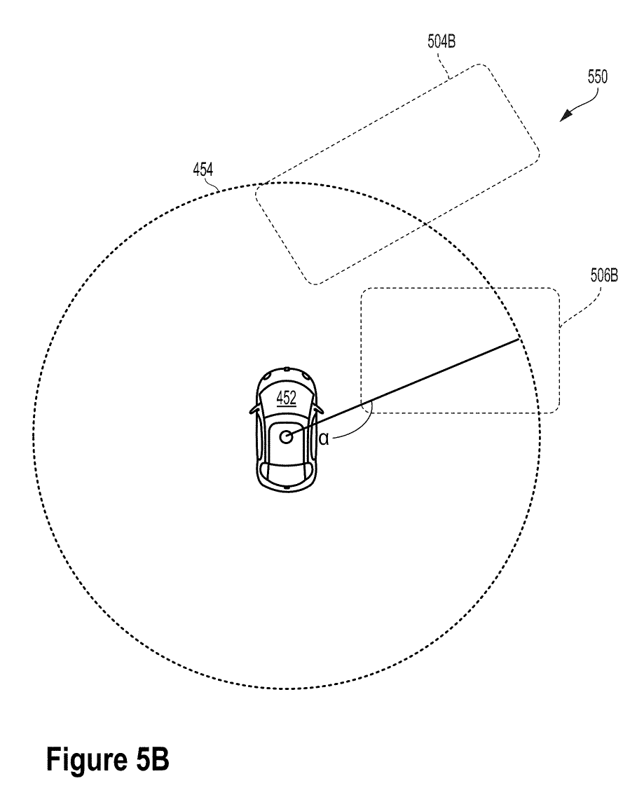

FIG. 5A illustrates a representation of a scene 500, according to an example embodiment. Specifically, FIG. 5A may illustrate a portion of a spatial point cloud of an environment based on data from the LIDAR system 310 of FIG. 3A. The spatial point cloud may represent a three-dimensional (3D) representation of the environment around a vehicle. The 3D representation may be generated by a computing device as a 3D point cloud based on the data from the LIDAR system 310 illustrated and described in reference to FIG. 3. Each point of the 3D cloud, for example, may include a reflected light pulse associated with a previously emitted light pulse from one or more LIDAR devices. The various points of the point cloud may be stored as, or turned into, an object grid for the LIDAR system. The object grid may additionally contain information about a distance and angle to the various points of the point cloud.

Based on the rotation of the scanning laser system 110, the scene 500 includes a scan of the environment in all directions (360° horizontally) as shown in FIG. 5A. Further, as shown, a region 504A is indicative of objects in the environment of the LIDAR device. For example, the objects in the region 504A may correspond to pedestrians, vehicles, or other obstacles in the environment of the LIDAR device 300. In some additional examples, the region 504A may contain fog, rain, or other obstructions. In particular, the region 504A may contain a vehicle driving on a wet road. The vehicle may cause water from the road to be sprayed up behind the vehicle. Theses obstructions, such as the water sprayed by a vehicle's tires, may appear as a solid object to a LIDAR system. Thus, a LIDAR system may interpret the objects incorrectly.

In an example scenario where the LIDAR system 310 is mounted to a vehicle such as the vehicle 300, the vehicle 300 may utilize the spatial point cloud information from the scene 500 to navigate the vehicle away from region 504A towards region 506A that does not include the obstacles of the region 504A.

FIG. 5B illustrates a representation of a scene 550, according to an example embodiment. Specifically, FIG. 5B may illustrate an azimuth plane object grid of an environment based on data from the RADAR system 380 of FIG. 3A. The object grid may represent objects of the environment around a vehicle. For example, the region 504B of FIG. 5B may be the same region 504A of FIG. 5A. Similarly, the region 506B of FIG. 5B may be the same region 506A of FIG. 5A. The vehicle may generate an object grid for the azimuth plane based on the reflections of objects that reflect the RADAR signals from the RADAR system 380. The object grid may include a distance, angle (<) and velocity for each object that reflects RADAR signals. In some examples, such as those that deal with fog, rain, exhaust condensation, etc., the RADAR system may be able to receive reflections from objects that the LIDAR system may not. For example, when a car sprays up water from a wet road, the LIDAR system may only see the water and think it is a stationary solid object. The RADAR system may be able to see through this water spray and see RADAR reflections from the vehicle causing the spray. Thus, the object grid created by the RADAR system may correctly image the vehicle.

### Method Examples

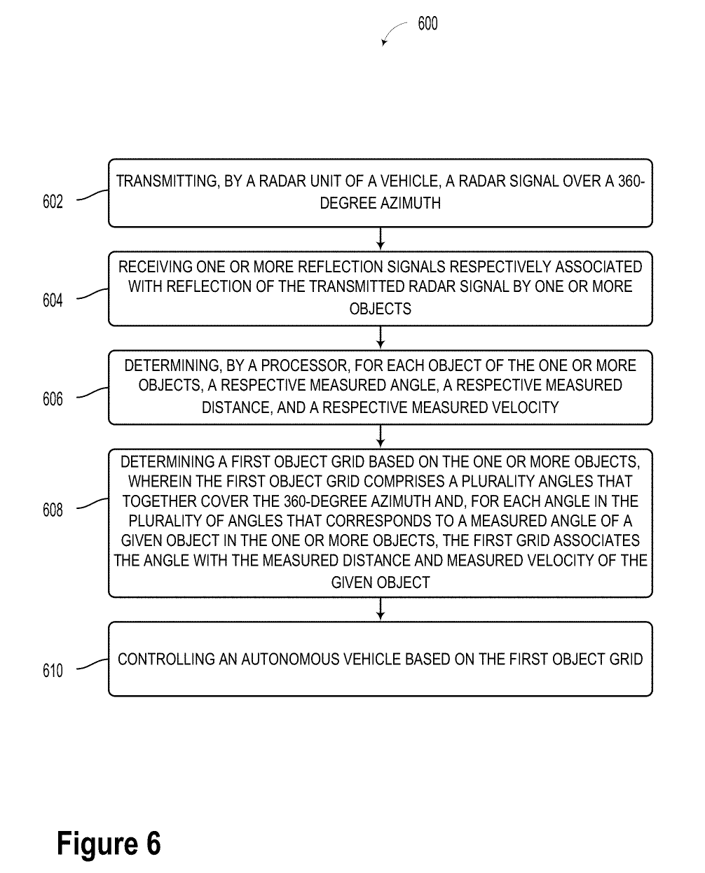

FIG. 6 illustrates a method 600, according to an example embodiment. The method 600 includes blocks that may be carried out in any order. Furthermore, various blocks may be added to or subtracted from method 600 within the intended scope of this disclosure. The method 600 may correspond to steps that may be carried out using any or all of the systems illustrated and described in reference to FIGS. 1, 2A-C, 3, 4A-4C, and 5A-B. That is, as described herein, method 600 may be performed by a LIDAR and RADAR and associated processing system of an autonomous vehicle.

Block 602 includes transmitting, by a radar unit of a vehicle, a radar signal over a 360-degree azimuth. In various example, the radar signal transmitted by the radar unit may be transmitted in various ways. For example, the radar signal may be scanned across the azimuth plane, or scanned across the azimuth plan and elevation plane. In other examples, the radar signal may be transmitted omnidirectionally and cover the full azimuth plane at once. In some instances, block 602 may also include transmitting a laser signal from a LIDAR unit of the vehicle. Similarly, the laser may be scanned across the azimuth plan and elevation plane.

Block 604 includes receiving one or more reflection signals respectively associated with reflection of the transmitted radar signal by one or more objects. The receiving radar unit may be configured in various different ways. In some examples, the radar unit may be configured to receive signals in an omnidirectional manner and perform digital beamforming on received radar signals. In some instances, block 604 may also include receiving at least one respective laser reflection signal associated with the transmitted LIDAR signal. The LIDAR signal may be received in an omnidirectional manner. The LIDAR system may be able to determine a direction from which the various laser reflections were received.

Block 606 includes determining, by a processor, for each object of the one or more objects, a respective measured angle, a respective measured distance, and a respective measured velocity. The angle that is determined may be an angle with the respect to the azimuth plane. In some additional examples, the angle may be both an angle with respect to the azimuth plane as well as an elevation angle. Block 606 may be performed with respect to either the radar signals, laser signals, or both laser and radar signals.

Block 608 includes determining a first object grid based on the one or more objects, wherein the first object grid comprises a plurality angles that together cover the 360-degree azimuth and, for each angle in the plurality of angles that corresponds to a measured angle of a given object in the one or more objects, the first grid associates the angle with the measured distance and measured velocity of the given object. The first object grid contains information about the various objects that reflected radar signals back to the vehicle. The first object grid may be divided into various segments based on a resolution of the radar system. In some examples, the resolution of the object grid may be 1 degree or less of the azimuth plane. The first object grid may include an angle, a distance, and a velocity for the reflections received by the radar unit. In some examples the object grid may be three dimensional and include both azimuth and elevation angles to the various reflections.

In some instances, block 608 further includes determining a second object grid based on at least one object that caused a laser reflection. The second object grid may be similar to the first object grid, but based on data from the laser reflections. The second object grid may include an angle and a distance for the reflections received by the LIDAR unit. In some examples, the second object grid may also contain velocity information for the reflections received by the LIDAR unit. However, because LIDAR may not provide as accurate velocity information for the various objects, the velocity information of the second object grid may come from the velocity information that forms the first object grid. A processing unit may be able to adjust and/or correlate the various objects of the second object grid with the velocities determined as part of the first object grid. In some further examples, errors in the second object grid may be removed based on the information from the first object grid. For example, the processing unit may be able to determine that an object in the second object grid, such as a condensation cloud, is not a solid object and can be removed from the object cloud. When data is removed from the object grid, data from the first object grid may be used to supplement the second object grid.

Block 610 includes controlling an autonomous vehicle based on the first object grid. The data from the object grid may enable the vehicle to know location and velocity parameters of objects near the vehicle. Thus, the movement of the vehicle may be controlled based on this information. For example, the vehicle may determine, via the first object grid, that a gate in front of the vehicle is closing. Therefore, the forward movement of the vehicle may be stopped in response to this movement of the gate. In another example, the vehicle may detect condensation from another vehicle as a solid object. However, the information from the first object grid may enable the vehicle to determine that the condensation is not a solid object. This determination may allow the vehicle to safely proceed in a forward direction through the condensation.

In some instances, block 610 includes controlling an autonomous vehicle based on both the first object grid and the second object grid. As previously discussed, the vehicle may use the first object grid to determine errors of the second object grid. Controlling an autonomous vehicle may be performed based on removing the errors from the second object grid. Additionally, a movement of objects in the second object grid may be determined based on data from the first object grid.

Although some example embodiments described herein relate to LIDAR and RADAR systems utilized in autonomous vehicles, it should be understood that similar systems and methods could be applied to many other scanning applications. For example, contemplated systems and methods include scenarios involving acoustic sensing, other optical sensing, etc.

In example embodiments, an example system may include one or more processors, one or more forms of memory, one or more input devices/interfaces, one or more output devices/interfaces, and machine readable instructions that when executed by the one or more processors cause the system to carry out the various functions tasks, capabilities, etc., of the method described above.

In some embodiments, the disclosed techniques (e.g., method 600) may be implemented by computer program instructions encoded on a computer readable storage media in a machine-readable format, or on other media or articles of manufacture. In one embodiment, an example computer program product is provided using a signal bearing medium. The signal bearing medium may include one or more programming instructions that, when executed by one or more processors may provide functionality or portions of the functionality described above with respect to FIGS. 1-6. In some examples, the signal bearing medium may be a non-transitory computer-readable medium, such as, but not limited to, a hard disk drive, a Compact Disc (CD), a Digital Video Disk (DVD), a digital tape, memory, etc. In some implementations, the signal bearing medium may be a computer recordable medium, such as, but not limited to, memory, read/write (R/W) CDs, R/W DVDs, etc. In some implementations, the signal bearing medium may be a communication medium (e.g., a fiber optic cable, a waveguide, a wired communications link, etc.). Thus, for example, the signal bearing medium may be conveyed by a wireless form of the communications medium.

The one or more programming instructions may be, for example, computer executable and/or logic implemented instructions. In some examples, a computing device may be configured to provide various operations, functions, or actions in response to the programming instructions conveyed to the computing device by one or more of the computer readable medium, the computer recordable medium, and/or the communications medium.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A method comprising:
transmitting, by a radar unit of a vehicle, a radar signal over a 360-degree azimuth;
receiving one or more reflection signals respectively associated with reflection of the transmitted radar signal by one or more objects;
determining, by a processor, for each object of the one or more objects, a respective measured angle, a respective measured distance, and a respective measured velocity;
determining a first object grid based on the one or more objects, wherein the first object grid comprises a plurality angles that together cover the 360-degree azimuth and, for each angle in the plurality of angles that corresponds to a measured angle of a given object in the one or more objects, the first grid associates the angle with the measured distance and measured velocity of the given object; and
controlling an autonomous vehicle based on the first object grid.

2. The method according to claim 1, further comprising:
receiving data from a second sensor;
determining a second object grid based on the data from a second sensor; and
wherein controlling an autonomous vehicle is performed based on the first object grid and the second object grid.

3. The method according to claim 2, wherein the second sensor is a LIDAR sensor.

4. The method according to claim 2, wherein the first object grid is used to determine errors of the second object grid, and wherein controlling an autonomous vehicle is performed based on removing the errors from the second object grid.

5. The method according to claim 2, wherein movement of objects in the second object grid is determined based on data from the first object grid.

6. The method according to claim 1, wherein the first object grid has an angular resolution of 1 degree or less.

7. The method according to claim 1, wherein the first object grid further comprises an elevation angle.

8. A system comprising:
a radar unit configured to transmit and receive radar signals over a 360-degree azimuth plane, wherein the receiving comprises receiving one or more reflection signals respectively associated with reflection of the transmitted radar signal by one or more objects;
a control unit configured to operate a vehicle according to a control plan;
a processing unit configured to:
determine for each object of the one or more objects, a respective measured angle, a respective measured distance, and a respective measured velocity;
determine a first object grid based on the one or more objects, wherein the first object grid comprises a plurality angles that together cover the 360-degree azimuth and, for each angle in the plurality of angles that corresponds to a measured angle of a given object in the one or more objects, the first grid associates the angle with the measured distance and measured velocity of the given object; and
alter the control plan based on the first object grid.

9. The system according to claim 8, further comprising:
a second sensor unit configured to receive a second set of sensor data;
the processing unit being further configured to:
determine a second object grid based on the second set of sensor data; and
wherein the control plan is altered based on the first object grid and the second object grid.

10. The system according to claim 9, wherein the second sensor is a LIDAR sensor.

11. The system according to claim 9, wherein the first object grid is used to determine errors of the second object grid, and wherein the control plan is altered based on removing the errors from the second object grid.

12. The system according to claim 9, wherein movement of objects in the second object grid is determined based on data from the first object grid.

13. The system according to claim 8, wherein the radar unit an angular resolution of 1 degree or less.

14. The system according to claim 8, wherein the first object grid further comprises an elevation angle.

15. An article of manufacture including a non-transitory computer-readable medium, having stored thereon program instructions that, if executed by a computing device, cause the computing device to perform operations comprising:
transmitting, by a radar unit of a vehicle, a radar signal over a 360-degree azimuth;
receiving one or more reflection signals respectively associated with reflection of the transmitted radar signal by one or more objects;
determining, by a processor, for each object of the one or more objects, a respective measured angle, a respective measured distance, and a respective measured velocity;
determining a first object grid based on the one or more objects, wherein the first object grid comprises a plurality angles that together cover the 360-degree azimuth and, for each angle in the plurality of angles that corresponds to a measured angle of a given object in the one or more objects, the first grid associates the angle with the measured distance and measured velocity of the given object; and
controlling an autonomous vehicle based on the first object grid.

16. The article of manufacture according to claim 15, further comprising:
receiving data from a second sensor;
determining a second object grid based on the data from a second sensor; and
wherein controlling an autonomous vehicle is performed based on the first object grid and the second object grid.

17. The article of manufacture according to claim 16, wherein the second sensor is a LIDAR sensor.

18. The article of manufacture according to claim 16, wherein the first object grid is used to determine errors of the second object grid, and wherein controlling an autonomous vehicle is performed based on removing the errors from the second object grid.

19. The article of manufacture according to claim 16, wherein movement of objects in the second object grid is determined based on data from the first object grid.

20. The article of manufacture according to claim 15, wherein the first object grid further comprises an elevation angle.
